(19) United States
(12) Patent Application Publication
(10) Pub. No.: US 2002/0013749 A1
(43) Pub. Date: Jan. 31, 2002

(54) Method for classifying an investment item by price pattern

(76) Inventor: John Ricciardi, London (GB)

Correspondence Address: GOODWIN PROCTER & HOAR LLP, 7 BECKER FARM RD, ROSELAND, NJ, 07068, US

(21) Appl. No.: 09/891,681

(22) Filed: Jun. 26, 2001

Related U.S. Application Data
(60) Provisional application No. 60/214,754, filed on Jun. 27, 2000.

(51) Int. Cl. G06F 17/60

(52) U.S. Cl. 705/35; 705/10

(57) ABSTRACT

The present invention is a novel analysis method whereby investment item from any market or index can be grouped into novel price pattern groups depending upon the investment item's price history over the course of a user-selected period of time. The unique manner in which these groups are formulated offers the user, or investment trader, a much fuller view of the performance of the investment item than the typical raw historical information regarding price for an investment item. Furthermore, since it is possible to apply this technique to many investment items, it allows the investment trader to view pricing trends outside of the traditional boundaries of markets, i.e., NYSE, NASDAQ, etc., or indexes, i.e., DOW JONES, S&P 500, etc. Rather, this technique allows the investment trader to view price trending patterns for any collection of investment items across any market, including global or foreign markets, for any desired period of time.

### RELATED UNITED STATES APPLICATIONS/CLAIM OF PRIORITY

This application is a non-provisional counterpart to, and claims the benefit of, co-pending U.S. Provisional Patent Application Ser. No. 60/214754, which was filed on Jun. 27, 2000 and entitled “Novel Web Site”. The entire disclosure of the forgoing patent application is incorporated by reference as if set forth at length herein.

### FIELD OF THE INVENTION

The present invention relates to a novel method designed toward the need for collection and management of price information from investment markets. More particularly, the present invention involves a novel analysis technique whereby investment items are grouped via respective unique historical price patterns over a user-selected period of time.

### BACKGROUND OF THE INVENTION

Presently, there are many web sites on the Internet that allow a user to access information regarding the U.S. investment markets. Typically, those web sites provide market information such as the current price of a particular investment item or index (or even a list of investment items or indexes), or some historical information in the form of charts or graphs that display the price movement of a selected investment item over some period of time (i.e. year, month, 5-days, 3-days, 1-day) selected by the user. Though such information can be considered useful, it is extremely limited or difficult to understand. Moreover, the information is usually provided only in set time periods and absent any useful context. For example, the historical prices of an investment item for the prior five day period may not be tremendously helpful to the investment trader interested in the investment's pattern over the course of the most recent few hours. Additionally, the basic historical pattern typically found in investment information-providing tools today provide only the raw historical numbers rather than providing price analysis trends specific to the investment traders desired time period.

Accordingly, a primary object of the present invention is to provide a novel method of gathering and determining price pattern information based upon the individual needs of an investment trader.

### SUMMARY OF THE INVENTION

The present invention, briefly described, is a novel method of analysis involving pricing trends of investment items. The novel technique involves the collection of investment items based upon their pricing trends over the course of a user-selected time period. The analysis results in investment items being classified into unique groups such as “Rocket”, “Climber”, “Jumper”, “Valley”, “Glider”, “Lowhook”, “Highhook”, “Slider”, “Mountain”, “Sinker”, “Stumbler”and “Bomb”. Each of the groups has a particular characteristic that is reached through a series of analytical steps using the price history for the investment item and the user-selected time period. The resultant group of investment items provides the investment trader with insightful information regarding the price pattern or trend of the investment items in a context more useful than raw historical prices.

### BRIEF DESCRIPTION OF THE DRAWINGS

Exemplary embodiments of the present invention are now briefly described with reference to the following drawings:

FIG. 1 illustrates a high level flowchart of the analytical steps involved in the grouping of investment items by these unique price pattern groups.

FIG. 1.1 illustrates a high level flowchart for determining the three historical price averages based upon the time parameter used in the invention.

FIG. 1.1.A illustrates a low level flowchart for determining the first of three historical price averages for an investment item.

FIG. 1.1.B illustrates a low level flowchart for determining the second of three historical price averages for an investment item.

FIG. 1.1.C illustrates a low level flowchart for determining the third of three historical price averages for an investment item.

FIG. 1.2 illustrates a high level flowchart for determining the recent volatility level of an investment item to ensure sufficient volatility to warrant assignment in a price pattern group other than “no pattern”.

FIG. 1.2.1 illustrates a low level flowchart for determining specific information used within the invention when verifying an investment item's recent volatility level.

FIG. 1.2.2 illustrates a low level flowchart for determining the equivalent of the first historical price average, only for the second most recent block of contiguous time, as measured by the time parameter.

FIG. 1.2.3 illustrates a low level flowchart for determining the equivalent of the second historical price average, only for the second most recent block of contiguous time, as measured by the time parameter.

FIG. 1.2.4 illustrates a low level flowchart for determining the equivalent of the third historical price average, only for the second most recent block of contiguous time, as measured by the time parameter.

FIG. 1.2.5 illustrates a low level flowchart for determining specific information that may be used within the invention to verify an investment item's volatility.

FIG. 1.3 illustrates a low level flowchart for determining the three price sectors used to represent the three possible sectors within which a price point may fall.

FIG. 1.4 illustrates a low level flowchart for determining the appropriate price pattern group when the first historical price average exceeds the second historical price average for an investment item with sufficient volatility.

FIG. 1.5 illustrates a low level flowchart for determining the appropriate price pattern group when the first historical price average does not exceed the second historical price average for an investment item with sufficient volatility.

### DETAILED DESCRIPTION OF PREFERRED EMBODIMENT

In the following detailed description of the preferred embodiment, reference is made to the accompanying drawings that form a part hereof, and in which is shown by way of illustration specific embodiments in which the invention may be practiced. The preferred embodiment is described in sufficient detail to enable those skilled in the art to practice the invention. It should be understood that other embodiments may be utilized and that structural, logical and electrical changes may be made without departing from the spirit and scope of the present invention. The following detailed description is therefore not to be taken in a limiting sense, and the scope of the present inventions is defined only by the appended claims. The leading digit(s) of the reference numbers in the Figures usually correspond to the Figure number, with the exception that identical components which appear in multiple Figures are identified by the same reference numbers.

The present invention is directed to a method for the collection and management of investment price information. In today's environment global investment, day trading, long-term trading and targeted portfolios, investors are in need of a method and system that provides to them the ability to track and manage investments with regard to their historical pricing trends, yet regardless of investment strategy or type. Accordingly, this invention addresses that need.

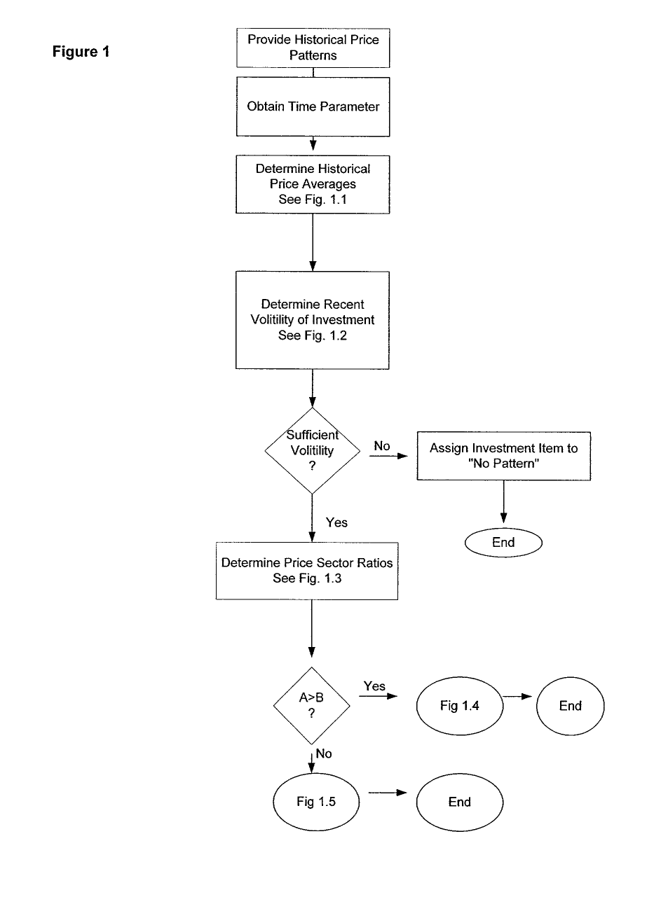

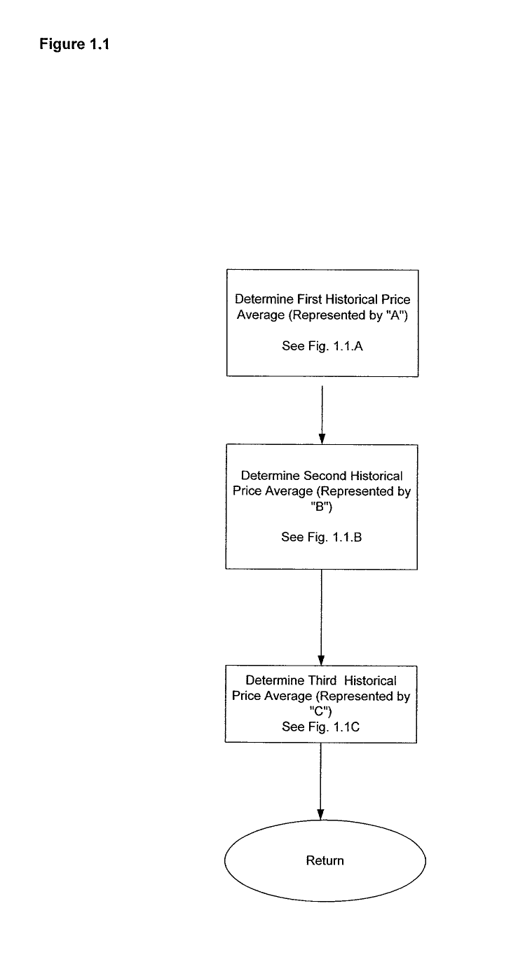

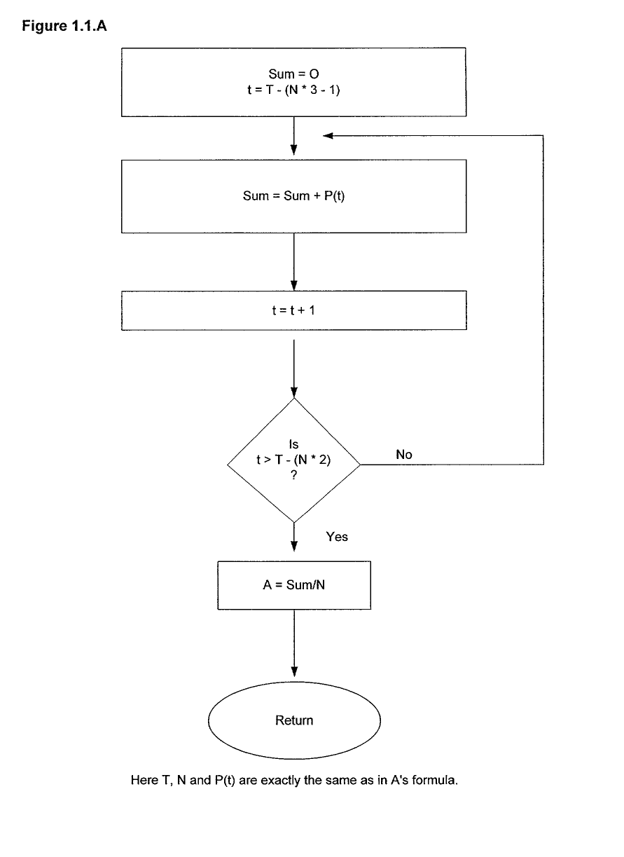

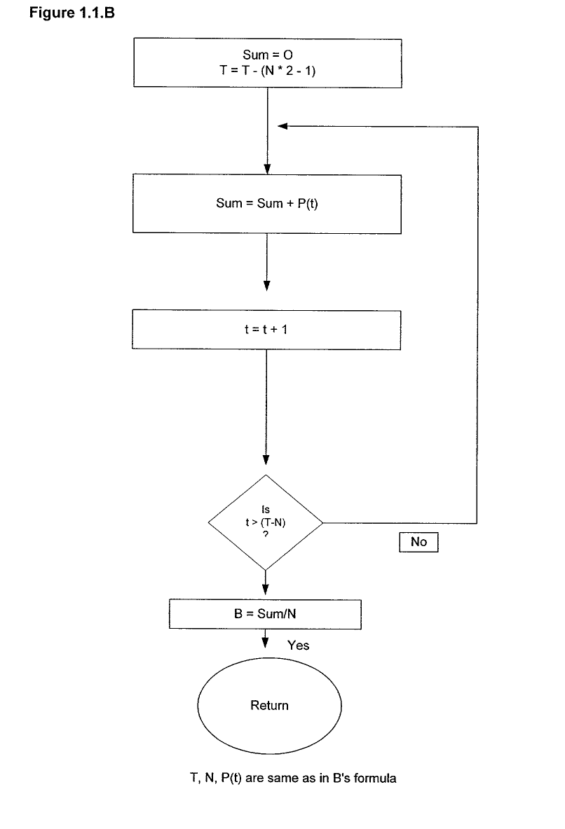

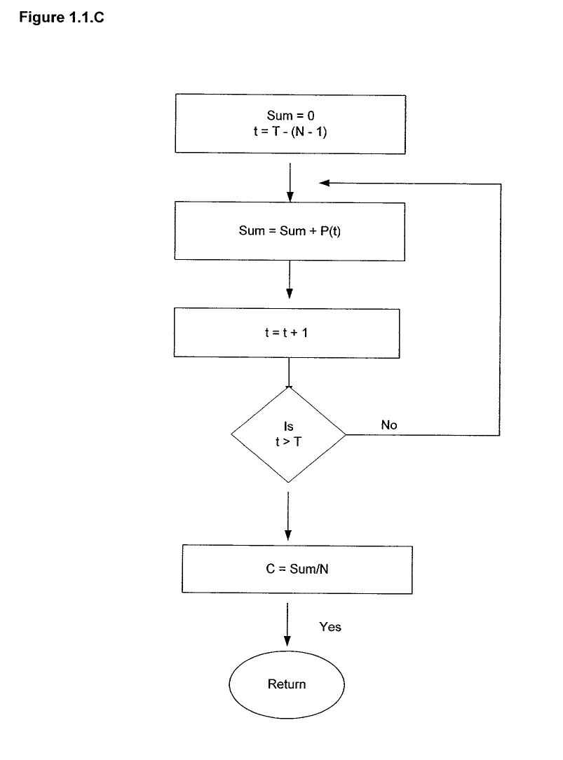

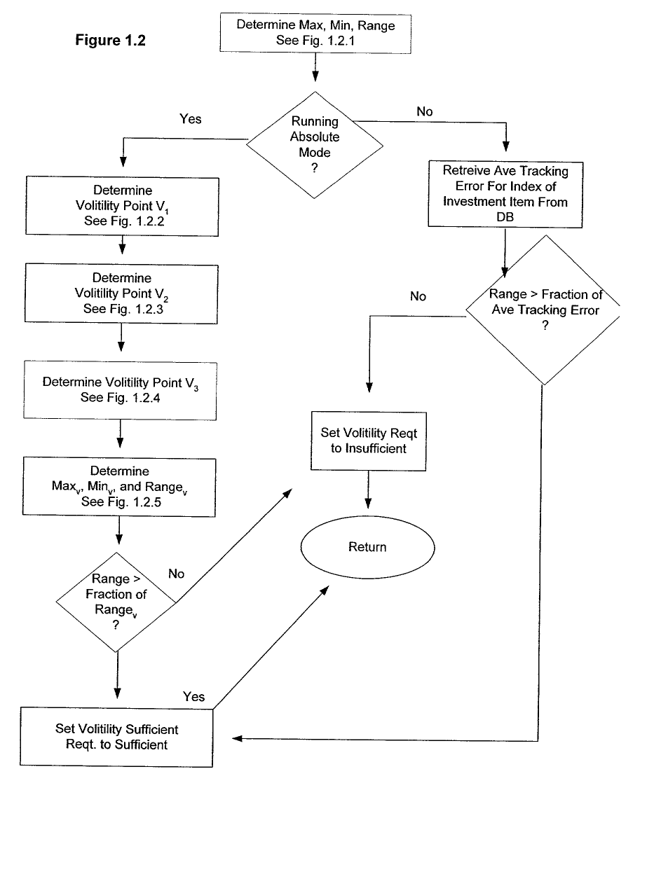

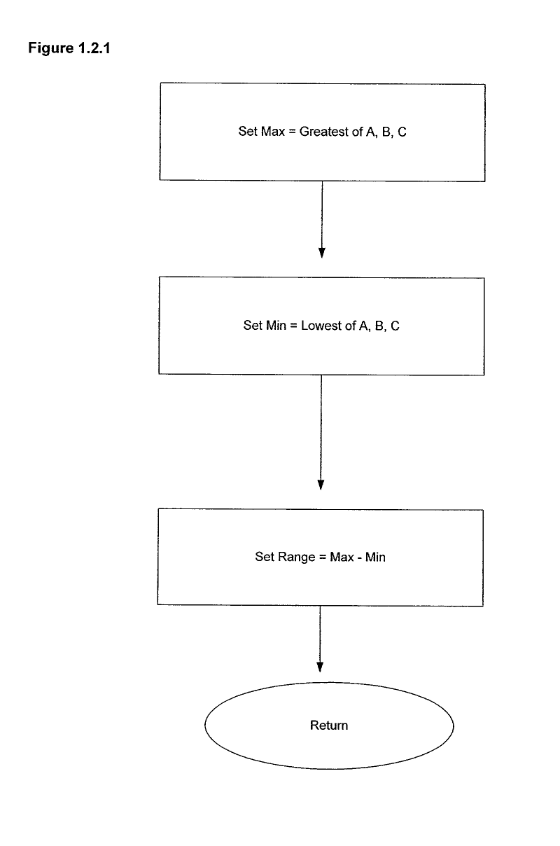

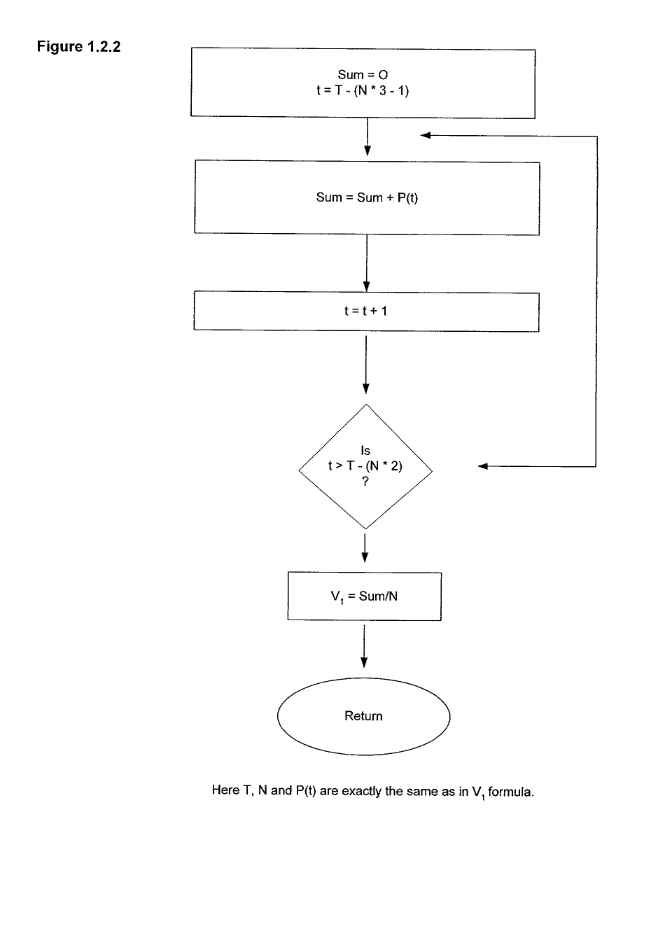

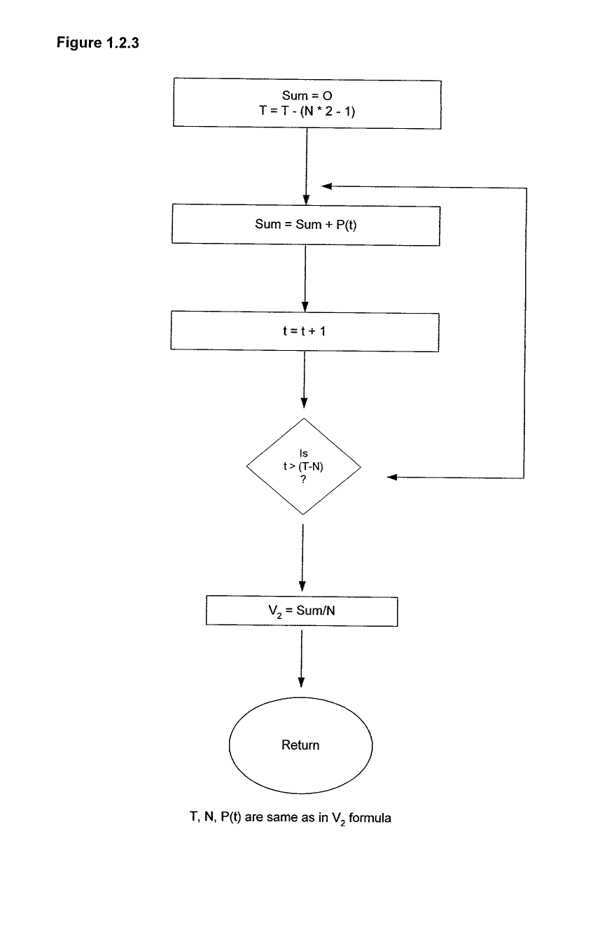

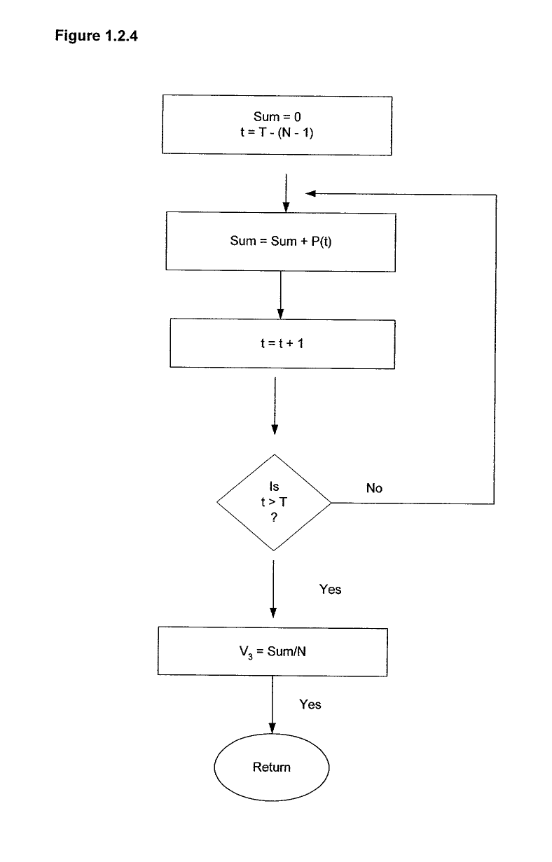

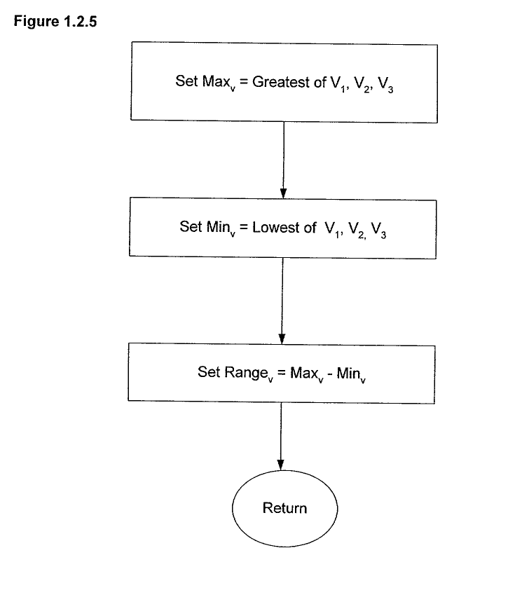

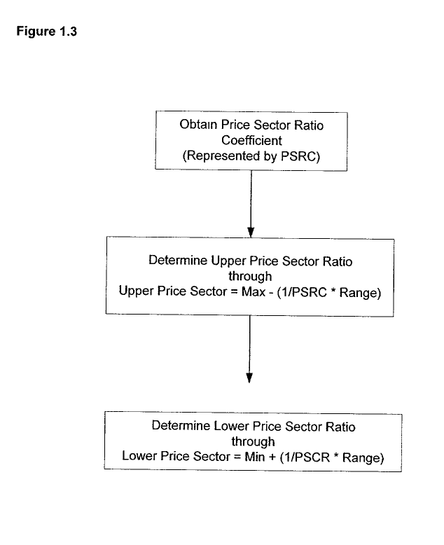

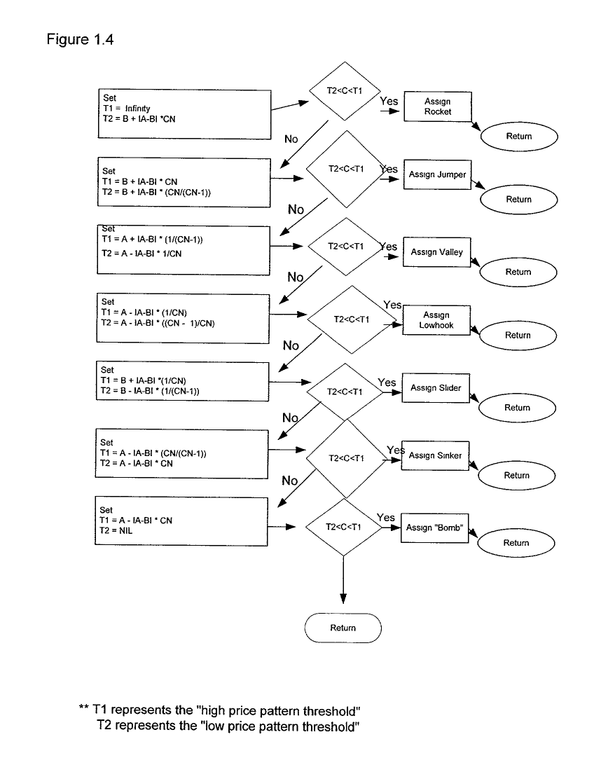

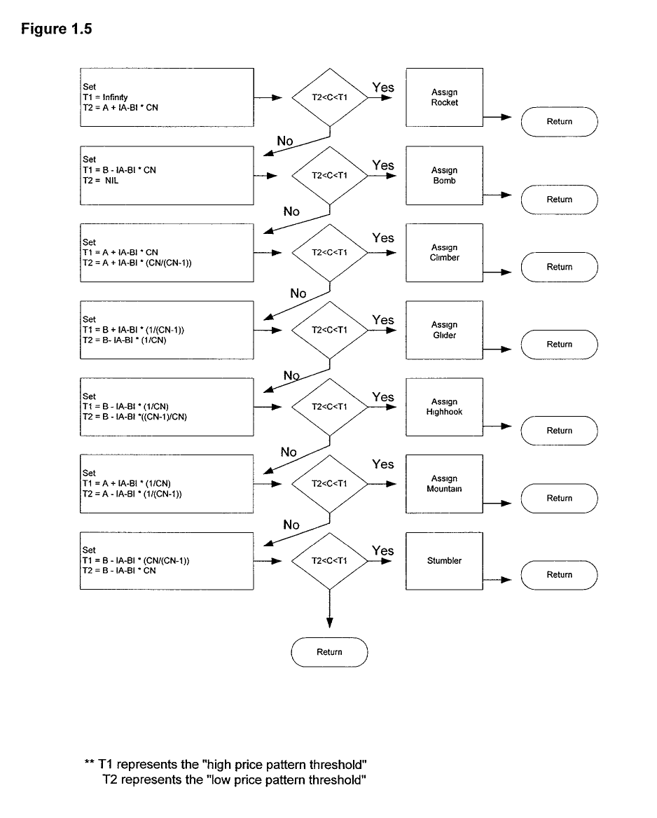

In accordance with the present invention, it is possible to classify any investment item into one of the above-listed price pattern groups, unless the analysis, as is depicted in the flowcharts of FIGS. 1 through 1.4, inclusive, yield the result that the particular investment item has no pricing trend for the selected time period matching the twelve listed, in which case, it will be classified as “no pattern”or “none”. The underlying foundation for these price pattern groups is a collection of three historical price averages, or price points, for the investment item. The three price points are calculated based upon the time parameter determined by the user, or otherwise provided.

For example, an investment item having a three price point value representation of A1B3C1 indicates that the investment item has a first price point A within the highest of the three price sectors, a second price point B within the lowest of the three price sectors, and a third price point C within the highest of the three price sectors. The value of this third price point, in comparison to the first and second points, is what is used to determine the overall price pattern characteristic or group. Price points A and B are averages of the past prices of the investment item over set periods of sequential time, determined from the time parameter value, while price point C can either be a determined average over a set time period or it can simply be the current price of the investment item.

For instance, if the time parameter is set by the user to be a mode of “days”, price point A will be the average price of the investment item from fourteen days ago to ten days ago (of course, once the mode is selected, the length of each time period, although consistent for purposes of calculating price points for an investent item, may be altered in other embodiments). Price point B will be the average price of the investment item from nine days ago to five days ago. And, price point C may be the average price of the investment item from four days ago to today, or it may be the current price of the investment item. The time parameter is determined by the user and can be set to any imaginable length of time; the analysis operates the same regardless.

The numerical symbols, or sector classifications, associated with each price point, i.e. “1” with price points A and C and “3” with price point B, represent their positions relative to calculated price sectors, where “1” signifies the associated price point falls within the upper price sector, “2” signifies the associated price point falls within the middle price sector (between the upper and lower price sectors), and “3” signifies the associated price point falls within the lower price sector. Price sectors represent a division of a generic priceline that begins at the lowest value of the three price points (Min) and extends to the highest value of the three price points (Max). The price sectors essentially divide the generic priceline into three sectors—upper, middle and lower. The ratio of each sector to the whole priceline is determined using a pre-determined price sector ratio coefficient. Of course, other embodiments of the invention may use a different coefficient value than what is used by the preferred embodiment.

Once values for the three price points are determined, the price volatility of the investment item is analyzed to determine if it qualifies for one of the twelve price pattern categories. For those investment items whose price movements are not sufficiently volatile will not qualify for any of the twelve categories and will be grouped into the “no pattern” group or “none”.

With regard to the twelve price pattern groups listed above (omitting the “no pattern” category), the groups can be divided into two divisions: (i) where price point A is exceeds price point B; and (ii) where price point A does not exceed price point B.

In the first division—where price point A exceeds price point B, five price pattern groups are exclusively included. These price patterns are “Jumper”, “Valley”, “Lowhook”, “Slider”, and “Sinker”. Whether the resulting price trend is positive or negative or tending toward neutral, depends upon the value of price point C relative to price point A and price point B. In the second division—where price point A does not exceed price point B, five other price pattern groups are exclusively included. These price pattern groups are “Climber”, “Glider”, “Highhook”, “Mountain”, and “Stumbler”. And, just as with the first division, again the resulting price trend for the investment item is entirely dependent upon the value of price point C relative to price point A and price point B.

Even with the two divisions, there are price pattern groups that transcend the divisions. Both the “Rocket” and the “Bomb” have characteristics that allow an investment item—regardless of the values of price point A and price point B—to qualify for either price pattern group. This is so for in both the “Rocket” and the “Bomb” price pattern groups, price point A and price point B qualify for the same price sector classification—either both are “1” or both are “3”—while price point C is dramatically inapposite in its price sector classification. Thus, the dramatic volatility of price point C relative to both price point A and price point B has the effect of minimizing the difference between price point A and price point B relative to price point C.

As for the specific calculations that occur when determining the price pattern group for an investment item, as FIG. 1 illustrates, once the price pattern groups are provided, there are four preliminary steps before price pattern group assignments can be determined. The first step is to obtain the desired time parameter from the user or another source. Once that step is accomplished, the three historical price averages, or price point A, price point B and price point C, must be determined. The third step is to analyze the volatility of the investment item to ensure it has sufficient price volatility over the course of the time parameter to qualify under one of the price pattern groups. If the investment item lacks sufficient volatility, it is grouped into the “no pattern” group; otherwise the fourth preliminary step—determining the price sectors—is performed and the pattern analysis continues.

As mentioned above, the three price points are the historical price averages for the investment item over equally divided portions of the time period. Price point A is the price average for the least recent (or most distant) one-third of time encompassed from the outset of the analysis (i.e., today) to the outer bound established from the user's selection of a time period mode. Thus, the relevant time for price point A begins at the outer most boundary (as depicted on a horizontal timeline spanning time from today back for the length of time specified as the time parameter) and moves forward through time until the amount of time transcended equals one-third of the total time established from the time parameter mode. The analytical steps for determining price point A are illustrated in FIG. 1.1.A and can also be summarized by one mathematical equation:

$$A = \frac{{\sum }_{t = T - ( N * 3 - 1 )}^{T - ( N * 2 )} Pt}{N}$$

where

Pt=Investment Item Daily Closing Price at any time t

T=Current Time

N=Pre-determined selected time period

Price point B is the price average for the middle one-third of the timeline described above. The analytical steps for determining price point B are illustrated in FIG. 1.1.B and can also be summarized by one mathematical equation:

$$B = \frac{{\sum }_{t = T - ( N * 2 - 1 )}^{T - N} Pt}{N}$$

where

Pt=Investment Item Daily Closing Price at any time t

T=Current Time

N=Pre-determined selected time

Finally, price point C may be the price average for the most recent one-third of time of the timeline described above. However, it may also be simply the current price of the investment item. Under the scenario where price point C is not assigned the current price, but, instead is the average of the most recent one-third of time, the analytical steps for determining price point C are illustrated in FIG. 1.1.C and can also be summarized by the mathematical equation:

$$C = \frac{{\sum }_{t = T - ( N - 1 )}^{T} Pt}{N}$$

where

Pt=Investment Item Daily Closing Price at any time t

T=Current Time

N=Pre-determined selected time

Once these price points have been calculated, as mentioned, the next step of the preliminary calculations, is to determine if the investment item satisfies the minimum volatility required to qualify for one of the twelve price pattern groups excluding the “no pattern” group.

To determine if an investment item has sufficient volatility, as illustrated in FIG. 1.2, the following analysis must occur. First, as FIG. 1.1.1 illustrates, from the three price points, the maximum value (Max) and minimum value (Min) must be determined. Additionally, the difference, or range (Range) between the maximum and minimum values is determined. Then, if the user is running in “absolute” mode, which means the price pattern analysis does not involve comparisons relative to its investment index (i.e. Dow Jones Industrial Average, S&P 500, etc.) variables V₁, V₂, V₃, Maxᵥ, Minᵥ, and Rangeᵥ are calculated as follows:

$${V}_{1} = \frac{{\sum }_{t = T - ( N * 3 - 1 )}^{T - ( N * 2 )} Pt}{N}$$

$$where \text{Pt} \text{= Investment Item Daily Closing Price at any time} \text{t} \\ \text{T} \text{= Current Time - (N * 3)} \text{N} \text{= Pre-determined selected time}$$

$${V}_{2} = \frac{{\sum }_{t = T - ( N * 2 - 1 )}^{T - N}}{N}$$

$$where \text{Pt} \text{= Investment Item Daily Closing Price at any time} \text{t} \\ \text{T} \text{= Current Time - (N * 3)} \text{N} \text{= Pre-determined selected time}$$

$${V}_{3} = \frac{{\sum }_{t = T - ( N - 1 )}^{T}}{N}$$

$$where \text{Pt} \text{= Investment Item Daily Closing Price at any time} \text{t} \\ \text{T} \text{= Current Time - (N * 3)} \text{N} \text{= Pre-determined selected time}$$

Maxᵥ=Greatest of V₁, V₂ and V₃

Minᵥ=Lowest of V₁, V₂ and V₃

Rangeᵥ−Maxᵥ Minᵥ

Then, in order to have sufficient volatility for grouping into a price pattern group, Range must be greater than a pre-determined ration of the value of Rangeᵥ. In mathematical terms, the question would possibly be:

Range>⅔ Rangeᵥ?

(Of course, the ⅔ ration in the above example could be different in other embodiments.) If the answer is affirmative (i.e., Range is greater than two-thirds the value of Rangeᵥ), then the investment item is deemed to have sufficient volatility over the course of the user-selected time period in comparison to the equivalent, most recent, prior time period. If the answer is negative, the investment item is grouped to the “no pattern” classification.

On the other hand, for a user running a “relative” mode, the calculations for V₁, V₂, V₃, Maxᵥ, Minᵥ and Rangeᵥ are not performed. Instead, the variable Range is used. More specifically, the value of Range must be greater than a pre-determined ration of the value of the Average Tracking Error calculated for the complete Index of the investment item. In mathematical terms, the question would be:

Range>⅓ Investment Item Index Average Tracking Error

(Again, of course, the ⅓ ration in the above example could be different in other embodiments.) If the answer is affirmative, the investment item is deemed to have sufficient volatility over the time period selected by the user. IF the answer is negative, the investment item is grouped into the “no pattern” classification, and the process steps.

The Average Tracking Error for an index is a pre-determined value based upon the price history of every investment item listed within the formal Index of the investment item currently being analyzed for a price pattern group. More specifically, the Average Tracking Error represents the performance distribution of all the investment items that comprise the Index for the time parameter.

Once an investment item satisfies the above-detailed volatility analysis, the process continues by determining the price sectors (see FIG. 1.3) then determining to which division of price pattern groups this investment item belongs. If price point A exceeds price point B, the analysis of the investment item follows the first division analysis steps as illustrated in FIG. 1.4; otherwise the analysis of the investment item follows the second division analysis steps as illustrated in FIG. 1.5.

As FIG. 1.4 illustrates, the first division analysis encompasses seven possible price pattern groups—Rocket, Jumper, Valley, LowHook, Slider, Sinker and Bomb. In order for an investment item to qualify for any of these seven price pattern groups, as mentioned above, the value of price point A (the first historical price average) must exceed the value of price point B (the second historical price average). Following that determination, a series of steps occurs to determine which of the seven price pattern groups is appropriate for the investment item given its price history and sufficient volatility.

Price point C of the investment item is checked against both the high and low price pattern thresholds for the Rocket price pattern group. For the Rocket, the high price pattern threshold is set to infinity, and the low price pattern threshold is determined through the following steps: (i) determine the absolute value of the result of subtracting price point B from price point A, (ii) multiply the result from step (i) by the Price Sector Ratio Coefficient (pre-determined for the user, see FIG. 1.3), and (iii) add the multiplication result to price point B. At this point, if price point C exceeds the low price pattern threshold, and does not exceed the high price pattern threshold, then the investment item qualifies as a “Rocket” and is assigned accordingly. Otherwise, the analysis continues.

The investment item is next checked against both the high and low price pattern thresholds for the Jumper price pattern group. For the Jumper, the high price pattern threshold is determined through the following steps: (i) determine the absolute value of the result of subtracting price point B from price point A, (ii) multiply the result from step (i) by the Price Sector Ratio Coefficient and (iii) add the multiplication result to price point B. The low price pattern threshold is determined through the following steps: (i) determine the absolute value of the result of subtracting price point B from price point A, (ii) divide the Price Sector Ratio Coefficient by the Price Sector Ratio Coefficient less one, (iii) multiply the result from step (i) by the result from step (ii), and (iv) add the multiplication result to price point B. At this point, if price point C exceeds the low price pattern threshold, and does not exceed the high price pattern threshold, then the investment item qualifies as a “Jumper” and is assigned accordingly. Otherwise, the analysis continues.

The investment item is next checked against both the high and low price pattern thresholds for the Valley price pattern group. For the Valley, the high price pattern threshold is determined through the following steps: (i) determine the absolute value of the result of subtracting price point B from price point A, (ii) divide one by the Price Sector Ratio Coefficient less one, (iii) multiply the result from step (i) by the result from step (ii), and (iv) add the multiplication result to price point A. The low price pattern threshold is determined through the following steps: (i) determine the absolute value of the result of subtracting price point B from price point A, (ii) divide one by the Price Secor Ratio Coefficient, (iii) multiply the result from step (i) by the result from step (ii), and (iv) subtract the multiplication result from price point A. At this point, if price point C exceeds the low price pattern threshold, and does not exceed the high price pattern threshold, then the investment item qualifies as a “Valley” and is assigned accordingly. Otherwise, the analysis continues.

The investment item is next checked against both the high and low price pattern thresholds for the LowHook price pattern group. For the LowHook, the high price pattern threshold is determined through the following steps: (i) determine the absolute value of the result of subtracting price point B from price point A, (ii) divide one by the Price Sector Ratio Coefficient, (iii) multiply the result from step (i) by the result from step (ii), and (iv) subtract the multiplication result from price point A. The low price pattern threshold is determined through the following steps: (i) determine the absolute value of the result of subtracting price point B from price point A, (ii) divide the Price Sector Ratio Coefficient less one by the Price Sector Ratio Coefficient, (iii) multiply the result from step (i) by the result from step (ii), and (iv) subtract the multiplication result from price point A. At this point, if price point C exceeds the low price pattern threshold, and does not exceed the high price pattern threshold, then the investment item qualifies as a “LowHook” and is assigned accordingly. Otherwise, the analysis continues.

The investment item is next checked against both the high and low price pattern thresholds for the Slider price pattern group. For the Slider, the high price pattern threshold is determined through the following steps: (i) determine the absolute value of the result of subtracting price point B from price point A, (ii) divide one by the Price Sector Ratio Coefficient, (iii) multiply the result from step (i) by the result from step (ii), and (iv) add the multiplication result from price point B. The low price pattern threshold is determined through the following steps: (i) determine the absolute value of the result of subtracting price point B from price point A, (ii) divide one by the Price Sector Ratio Coefficient less one, (iii) multiply the result from step (i) by the result from step (ii), and (iv) subtract the multiplication result from price point B. At this point, if price point C exceeds the low price pattern threshold, and does not exceed the high price pattern threshold, then the investment item qualifies as a “Slider” and is assigned accordingly. Otherwise, the analysis continues.

The investment item is next checked against both the high and low price pattern thresholds for the Sinker price pattern group. For the Sinker, the high price pattern threshold is determined through the following steps: (i) determine the absolute value of the result of subtracting price point B from price point A, (ii) divide the Price Sector Ratio Coefficient by the Price Sector Ratio Coefficient less one, (iii) multiply the result from step (i) by the result from step (ii), and (iv) subtract the multiplication result from price point A. The low price pattern threshold is determined through the following steps: (i) determine the absolute value of the result of subtracting price point B from price point A, (ii) multiply the result from step (i) by the Price Sector Ratio Coefficient, and (iii) subtract the multiplication result from price point A. At this point, if price point C exceeds the low price pattern threshold, and does not exceed the high price pattern threshold, then the investment item qualifies as a “Sinker” and is assigned accordingly. Otherwise, the analysis continues.

The investment item is next checked against both the high and low price pattern thresholds for the Bomb price pattern group. For the Bomb, the high price pattern threshold is determined through the following steps: (i) determine the absolute value of the result of subtracting price point B from price point A, (ii) multiply the result from step (i) by the Price Sector Ratio Coefficient, and (iii) subtract the multiplication result from price point A. The low price pattern threshold is set to nil. At this point, if price point C exceeds the low price pattern threshold, and does not exceed the high price pattern threshold, then the investment item qualifies as a “Bomb” and is assigned accordingly.

As illustrated in FIG. 1, when price point A does not exceed price point B, the second division analysis of price pattern groups is implicated. As FIG. 1.5 illustrates, seven possible price pattern groups are analyzed—Rocket, Climber, Glider, HighHook, Mountain, Stumbler and Bomb. It is important to note that both the first and second divisions allow for the possibility that the investment item will qualify as either a Rocket or a Bomb. This is true since it is possible that price point A and price point B will be extremely close in value (regardless of which is greater) relative to price point C. In that scenario, the investment item, due to the dramatic change in price (as reflected in price point C), could still qualify as either a Rocket or Bomb. In other words, the drastic change of price point C, relative to price point A and price point B, have the effect of minimizing the difference between price point A and price point B.

As FIG. 1.5 illustrates, just as with the first division analysis, this second division analysis involves a series of steps to determine the appropriate price pattern group, given price point B exceeds price point A and the investment item's sufficient volatility.

The investment item is checked against both the high and low price pattern thresholds for the Rocket price pattern group. For the Rocket, the high price pattern threshold is set to infinity, and the low price pattern threshold is determined through the following steps: (i) determine the absolute value of the result of subtracting price point B from price point A, (ii) multiply the result from step (i) by the Price Sector Ratio Coefficient, and (iii) add the multiplication result to price point A. At this point, if price point C exceeds the low price pattern threshold, and does not exceed the high price pattern threshold, then the investment item qualifies as a “Rocket” and is assigned accordingly. Otherwise, the analysis continues.

The investment item is next checked against both the high and low price pattern thresholds for the Climber price pattern group. For the Climber, the high price pattern threshold is determined through the following steps: (i) determine the absolute value of the result of subtracting price point B from price point A, (ii) multiply the result from step (i) by the Price Sector Ratio Coefficient and (iii) add the multiplication result to price point A. The low price pattern threshold is determined through the following steps: (i) determine the absolute value of the result of subtracting price point B from price point A, (ii) divide the Price Sector Ratio Coefficient by the Price Sector Ratio Coefficient less one, (iii) multiply the result from step (i) by the result from step (ii), and (iv) add the multiplication result to price point A. At this point, if price point C exceeds the low price pattern threshold, and does not exceed the high price pattern threshold, then the investment item qualifies as a “Climber” and is assigned accordingly. Otherwise, the analysis continues.

The investment item is next checked against both the high and low price pattern thresholds for the Glider price pattern group. For the Glider, the high price pattern threshold is determined through the following steps: (i) determine the absolute value of the result of subtracting price point B from price point A, (ii) divide one by the Price Sector Ratio Coefficient less one, (iii) multiply the result from step (i) by the result from step (ii), and (iv) add the multiplication result to price point B. The low price pattern threshold is determined through the following steps: (i) determine the absolute value of the result of subtracting price point B from price point A, (ii) divide one by the Price Sector Ratio Coefficient, (iii) multiply the result from step (i) by the result from step (ii), and (iv) subtract the multiplication result from price point B. At this point, if price point C exceeds the low price pattern threshold, and does not exceed the high price pattern threshold, then the investment item qualifies as a “Glider” and is assigned accordingly. Otherwise, the analysis continues.

The investment item is next checked against both the high and low price pattern thresholds for the HighHook price pattern group. For the HighHook, the high price pattern threshold is determined through the following steps: (i) determine the absolute value of the result of subtracting price point B from price point A, (ii) divide one by the Price Sector Ratio Coefficient, (iii) multiply the result from step (i) by the result from step (ii), and (iv) subtract the multiplication result from price point B. The low price pattern threshold is determined through the following steps: (i) determine the absolute value of the result of subtracting price point B from price point A, (ii) divide the Price Sector Ratio Coefficient less one by the Price Sector Ratio Coefficient, (iii) multiply the result from step (i) by the result from step (ii), and (iv) subtract the multiplication result from price point B. At this point, if price point C exceeds the low price pattern threshold, and does not exceed the high price pattern threshold, then the investment item qualifies as a “HighHook” and is assigned accordingly. Otherwise, the analysis continues.

The investment item is next checked against both the high and low price pattern thresholds for the Mountain price pattern group. For the Mountain, the high price pattern threshold is determined through the following steps: (i) determine the absolute value of the result of subtracting price point B from price point A, (ii) divide one by the Price Sector Ratio Coefficient, (iii) multiply the result from step (i) by the result from step (ii), and (iv) add the multiplication result from price point A. The low price pattern threshold is determined through the following steps: (i) determine the absolute value of the result of subtracting price point B from price point A, (ii) divide one by the Price Sector Ratio Coefficient less one, (iii) multiply the result from step (i) by the result from step (ii), and (iv) subtract the multiplication result from price point A. At this point, if price point C exceeds the low price pattern threshold, and does not exceed the high price pattern threshold, then the investment item qualifies as a “Mountain” and is assigned accordingly. Otherwise, the analysis continues.

The investment item is next checked against both the high and low price pattern thresholds for the Stumbler price pattern group. For the Stumbler, the high price pattern threshold is determined through the following steps: (i) determine the absolute value of the result of subtracting price point B from price point A, (ii) divide the Price Sector Ratio Coefficient by the Price Sector Ratio Coefficient less one, (iii) multiply the result from step (i) by the result from step (ii), and (iv) subtract the multiplication result from price point B. The low price pattern threshold is determined through the following steps: (i) determine the absolute value of the result of subtracting price point B from price point A, (ii) multiply the result from step (i) by the Price Sector Ratio Coefficient, and (iii) subtract the multiplication result from price point B. At this point, if price point C exceeds the low price pattern threshold, and does not exceed the high price pattern threshold, then the investment item qualifies as a “Stumbler” and is assigned accordingly. Otherwise, the analysis continues.

The investment item is next checked against both the high and low price pattern thresholds for the Bomb price pattern group. For the Bomb, the high price pattern threshold is determined through the following steps: (i) determine the absolute value of the result of subtracting price point B from price point A, (ii) multiply the result from step (i) by the Price Sector Ratio Coefficient, and (iii) subtract the multiplication result from price point B. The low price pattern threshold is set to nil. At this point, if price point C exceeds the low price pattern threshold, and does not exceed the high price pattern threshold, then the investment item qualifies as a “Bomb” and is assigned accordingly.

For investment items that do not fit into any of the above described price pattern groups within either the first or second divisions, they are labeled as having no discernable price pattern groups.

Having now described the preferred embodiment of the present invention, it should be apparent to those skilled in the art that the foregoing is illustrative only and not limiting, having been presented by way of example only. All the features disclosed in this specification (including any accompanying claims, abstract, and drawings) may be replaced by alternative features serving the same purpose, equivalents or similar purpose, unless expressly stated otherwise. Therefore, numerous other embodiments of the modifications thereof are contemplated as falling within the scope of the present invention as defined by the appended claims and equivalents thereto.

What is claimed is:

1. A method for classifying an investment item by historical price pattern, comprising the steps of:
providing a plurality of said historical price patterns, each having associated therewith predefined logic rules;
obtaining a time parameter;
determining a first historical price average for said investment item;
determining a second historical price average for said investment item;
determining a third historical price average for said investment item;
verifying said investment item price activity exceeds a minimum volatility;
selecting an applicable historical price pattern for said investment item from said plurality of historical price patterns using said first historical price average, said second historical price average, and said third historical price average.

2. A method according to claim 1 wherein said time parameter is measured in any block of time.

3. A method according to claim 1 wherein said first historical price average is the most distant one-third of said time parameter.

4. A method according to claim 1 wherein said second historical price average is the middle one-third of said time parameter.

5. A method according to claim 1 wherein said third historical price average is the most recent one-third of said time parameter.

6. A method according to claim 1 wherein said third historical price average is the current price for said investment item.

7. A method according to claim 1 wherein said time parameter is determined by a user.

8. A method according to claim 1 wherein said time parameter is pre-determined.

9. A method according to claim 1 wherein said minimum volatility is determined by the steps of:
determining a first minimum value from the group consisting of said first historical price average, said second historical price average, and said third historical price average;
determining a first maximum value from the group consisting of said first historical price average, said second historical price average, and said third historical price average;
determining a first range value by subtracting said first minimum value from said first maximum value;
verifying said first range value is greater than two-thirds of the value of a volatility threshold.

10. A method according to claim 9 wherein said volatility threshold is set to an average tracking error value.

11. A method according to claim 9 wherein said volatility threshold is determined by the steps of:
determining a fourth historical price average for an investment item;
determining a fifth historical price average for said investment item;
determining a sixth historical price average for said investment item;
determining a second minimum value from the group consisting of said fourth historical price average, said fifth historical price average, and said sixth historical price average;
determining a second maximum value from the group consisting of said fourth historical price average, said fifth historical price average, and said sixth historical price average;
determining a second range value by subtracting said second minimum value from said second maximum value;
assigning said volatility threshold the value of said second range value.

12. A method according to claim 11 wherein said fourth historical price average is the most distant of the second most recent block of time as measured by said time parameter.

13. A method according to claim 11 wherein said fifth historical price average is the middle one-third of the second most recent block of time as measured by said time parameter.

14. A method according to claim 11 wherein said sixth historical price average is the most recent one-third of the second most recent block of time as measured by said time parameter.

15. A method according to claim 1 wherein said price pattern classification for said investment item is determined to be “no pattern” for having insufficient volatility.

16. A method according to claim 1 wherein said plurality of historical price patterns includes an rocket, bomb, slider, glider, mountain, valley, sinker, jumper, climber, stumbler, lowhook, and highhook.

17. A method according to claim 16 wherein the step of selecting said applicable historical price pattern includes the steps of:
determining a Price Sector Ratio Coefficient;
if said first historical price average greater than said second historical price average, performing the following:
label said investment item as said rocket if said logic rules for said rocket are fulfilled;
label said investment item as said jumper if said logic rules for said jumper are fulfilled;
label said investment item as said valley if said logic rules for said valley are fulfilled;
label said investment item as said lowhook if said logic rules for said lowhook are fulfilled;
label said investment item as said slider if said logic rules for said slider are fulfilled;
label said investment item as said sinker if said logic rules for said sinker are fulfilled;
label said investment item as said bomb if said logic rules for said bomb are fulfilled;
if said first historical price average less than said second historical price average, performing the following:
label said investment item as said rocket if said logic rules for said rocket are fulfilled;
label said investment item as said climber if said logic rules for said climber are fulfilled;
label said investment item as said glider if said logic rules for said glider are fulfilled;
label said investment item as said highhook if said logic rules for said highhook are fulfilled;
label said investment item as said mountain if said logic rules for said mountain are fulfilled;
label said investment item as said stumbler if said logic rules for said stumbler are fulfilled;
label said investment item as said bomb if said logic rules for said bomb are fulfilled.

18. A method according to claim 17 wherein said Price Sector Ratio Coefficient is pre-determined.

19. A method according to claim 17 wherein said Price Sector Ratio Coefficient is provided by a user.

20. A method according to claim 17 wherein said logic rules for said rocket include the steps of:
determining a high price pattern threshold;
determining a low price pattern threshold;
verifying said first historical price average is less than said low price pattern threshold;
verifying said second historical price average is less than said low price pattern threshold;
verifying said third historical price average is greater than said high price pattern threshold.

21. A method according to claim 20 wherein said high price pattern threshold is set to infinity.

22. A method according to claim 20 wherein said low price pattern threshold is determined by the steps of:
determining an absolute value of said first historical price average less said second historical price average;
determining a first result by multiplying said absolute value by said Price Sector Ratio Coefficient;
adding said first result to said second historical price average.

23. A method according to claim 17 wherein said logic rules for said jumper include the steps of:
determining a high price pattern threshold;
determining a low price pattern threshold;
verifying said first historical price average is less than said high price pattern threshold;
verifying said first historical price average is greater than said low price pattern threshold;
verifying said second historical price average is less than said low price pattern threshold;
verifying said third historical price average is greater than said high price pattern threshold.

24. A method according to claim 23 wherein said high price pattern threshold is determined by the steps of:
determining an absolute value of said first historical price average less said second historical price average;
determining a first result by multiplying said absolute value by said Price Sector Ratio Coefficient;
adding said first result to said second historical price average.

25. A method according to claim 23 wherein said low price pattern threshold is determined by the steps of:
determining an absolute value of said first historical price average less said second historical price average;
determining a first result by subtracting one from said Price Sector Ratio Coefficient;
determining a second result by dividing said Price Sector Ratio Coefficient by said first result;
determining a third result by multiplying said absolute value by said second result;
adding said third result to said second historical price average.

26. A method according to claim 17 wherein said logic rules for said valley include the steps of:
determining a high price pattern threshold;
determining a low price pattern threshold;
verifying said first historical price average is greater than said high price pattern threshold;
verifying said second historical price average is less than said low price pattern threshold;
verifying said third historical price average is greater than said high price pattern threshold.

27. A method according to claim 26 wherein said high price pattern threshold is determined by the steps of:
determining an absolute value of said first historical price average less said second historical price average;
determining a first result by subtracting one from said Price Sector Ratio Coefficient;
determining a second result by dividing one by said first result;
determining a third result by multiplying said absolute value by said second result;
adding said third result to said first historical price average.

28. A method according to claim 26 wherein said low price pattern threshold is determined by the steps of:
determining an absolute value of said first historical price average less said second historical price average;
determining a first result by dividing one by said Price Sector Ratio Coefficient;
determining a second result by multiplying said absolute value by said first result;
subtracting said second result from said first historical price average.

29. A method according to claim 17 wherein said logic rules for said lowhook include the steps of:
determining a high price pattern threshold;
determining a low price pattern threshold;
verifying said first historical price average is greater than said high price pattern threshold;
verifying said second historical price average is less than said low price pattern threshold;
verifying said third historical price average is less than said high price pattern threshold;
verifying said third historical price average is greater than said low price pattern threshold.

30. A method according to claim 29 wherein said high price pattern threshold is determined by the steps of:
determining an absolute value of said first historical price average less said second historical price average;
determining a first result by dividing one by said Price Sector Ratio Coefficient;
determining a second result by multiplying said absolute value by said first result;
subtracting said second result from said first historical price average.

31. A method according to claim 29 wherein said low price pattern threshold is determined by the steps of:
determining an absolute value of said first historical price average less said second historical price average;
determining a first result by subtracting one from said Price Sector Ratio Coefficient;
determining a second result by dividing said first result by said Price Sector Ratio Coefficient;
determining a third result by multiplying said absolute value by said second result;
subtracting said third result from said first historical price average.

32. A method according to claim 17 wherein said logic rules for said slider include the steps of:
determining a high price pattern threshold;
determining a low price pattern threshold;
verifying said first historical price average is greater than said high price pattern threshold;
verifying said second historical price average is less than said low price pattern threshold;
verifying said third historical price average is less than said low price pattern threshold.

33. A method according to claim 32 wherein said high price pattern threshold is determined by the steps of:
determining an absolute value of said first historical price average less said second historical price average;
determining a first result by dividing one by said Price Sector Ratio Coefficient;
determining a second result by multiplying said absolute value by said first result;
adding said second result to said second historical price average.

34. A method according to claim 32 wherein said low price pattern threshold is determined by the steps of:
determining an absolute value of said first historical price average less said second historical price average;
determining a first result by subtracting one from said Price Sector Ratio Coefficient;
determining a second result by dividing one by said first result;
determining a third result by multiplying said absolute value by said second result;
subtracting said third result from said second historical price average.

35. A method according to claim 17 wherein said logic rules for said sinker include the steps of:
determining a high price pattern threshold;
determining a low price pattern threshold;
verifying said first historical price average is greater than said high price pattern threshold;
verifying said second historical price average is less than said high price pattern threshold;
verifying said second historical price average is greater than said low price pattern threshold;
verifying said third historical price average is less than said low price pattern threshold.

36. A method according to claim 35 wherein said high price pattern threshold is determined by the steps of:
determining an absolute value of said first historical price average less said second historical price average;
determining a first result by subtracting one from said Price Sector Ratio Coefficient;
determining a second result by dividing said Price Sector Ratio Coefficient by said first result;
determining a third result by multiplying said absolute value by said second result;
subtracting said third result from said first historical price average.

37. A method according to claim 35 wherein said low price pattern threshold is determined by the steps of:
determining an absolute value of said first historical price average less said second historical price average;
determining a first result by multiplying said absolute value by said Price Sector Ratio Coefficient;
subtracting said first result from said first historical price average.

38. A method according to claim 17 wherein said logic rules for said bomb include the steps of:
determining a high price pattern threshold;
determining a low price pattern threshold;
verifying said first historical price average is greater than said high price pattern threshold;
verifying said second historical price average is greater than said high price pattern threshold;
verifying said third historical price average is less than said low price pattern threshold.

39. A method according to claim 38 wherein said high price pattern threshold is determined by the steps of:
determining an absolute value of said first historical price average less said second historical price average;
determining a first result by multiplying said absolute value by said Price Sector Ratio Coefficient;
subtracting said first result from said first historical price average.

40. A method according to claim 38 wherein said low price pattern threshold is set to nil.

41. A method according to claim 17 wherein said logic rules for said rocket include the steps of:
determining a high price pattern threshold;
determining a low price pattern threshold;
verifying said first historical price average is less than said low price pattern threshold;
verifying said second historical price average is less than said low price pattern threshold;
verifying said third historical price average is greater than said high price pattern threshold.

42. A method according to claim 41 wherein said high price pattern threshold is set to infinity.

43. A method according to claim 41 wherein said low price pattern threshold is determined by the steps of:
determining an absolute value of said first historical price average less said second historical price average;
determining a first result by multiplying said absolute value by said Price Sector Ratio Coefficient;
adding said first result to said first historical price average.

44. A method according to claim 17 wherein said logic rules for said bomb include the steps of:
determining a high price pattern threshold;
determining a low price pattern threshold;
verifying said first historical price average is greater than said high price pattern threshold;
verifying said second historical price average is greater than said high price pattern threshold;
verifying said third historical price average is less than said low price pattern threshold.

45. A method according to claim 44 wherein said high price pattern threshold is determined by the steps of:
determining an absolute value of said first historical price average less said second historical price average;
determining a first result by multiplying said absolute value by said Price Sector Ratio Coefficient;
subtracting said first result from said second historical price average.

46. A method according to claim 44 wherein said high price pattern threshold is set to nil.

47. A method according to claim 17 wherein said logic rules for said climber include the steps of:
determining a high price pattern threshold;
determining a low price pattern threshold;
verifying said first historical price average is less than said low price pattern threshold;
verifying said second historical price average is greater than said low price pattern threshold;
verifying said second historical price average is less than said high price pattern threshold;
verifying said third historical price average is greater than said high price pattern threshold.

48. A method according to claim 47 wherein said high price pattern threshold is determined by the steps of:
determining an absolute value of said first historical price average less said second historical price average;
determining a first result by multiplying said absolute value by said Price Sector Ratio Coefficient;
adding said first result to said first historical price average.

49. A method according to claim 47 wherein said low price pattern threshold is determined by the steps of:
determining an absolute value of said first historical price average less said second historical price average;
determining a first result by subtracting one from said Price Sector Ratio Coefficient;
determining a second result by dividing said Price Sector Ratio Coefficient by said first result;
determining a third result by multiplying said absolute value by said second result;
adding said third result to said first historical price average.

50. A method according to claim 17 wherein said logic rules for said glider include the steps of:
determining a high price pattern threshold;
determining a low price pattern threshold;
verifying said first historical price average is less than said low price pattern threshold;
verifying said second historical price average is greater than said high price pattern threshold;
verifying said third historical price average is greater than said high price pattern threshold.

51. A method according to claim 50 wherein said high price pattern threshold is determined by the steps of:
determining an absolute value of said first historical price average less said second historical price average;
determining a first result by subtracting one from said Price Sector Ratio Coefficient;
determining a second result by dividing one by said first result;
determining a third result by multiplying said absolute value by said second result;
adding said third result to said second historical price average.

52. A method according to claim 50 wherein said low price pattern threshold is determined by the steps of:
determining an absolute value of said first historical price average less said second historical price average;
determining a first result by dividing one by said Price Sector Ratio Coefficient;
determining a second result by multiplying said absolute value by said first result;
subtracting said second result from said second historical price average.

53. A method according to claim 17 wherein said logic rules for said highhook include the steps of:
determining a high price pattern threshold;
determining a low price pattern threshold;
verifying said first historical price average is less than said low price pattern threshold;
verifying said second historical price average is greater than said high price pattern threshold;
verifying said third historical price average is greater than said low price pattern threshold;
verifying said third historical price average is less than said high price pattern threshold.

54. A method according to claim 53 wherein said high price pattern threshold is determined by the steps of:
determining an absolute value of said first historical price average less said second historical price average;
determining a first result by dividing one by said Price Sector Ratio Coefficient;
determining a second result by multiplying said absolute value by said first result;
subtracting said second result from said second historical price average.

55. A method according to claim 54 wherein said low price pattern threshold is determined by the steps of:
determining an absolute value of said first historical price average less said second historical price average;
determining a first result by subtracting one from said Price Sector Ratio Coefficient;
determining a second result by dividing said first result by said Price Sector Ratio Coefficient;
determining a third result by multiplying said absolute value by said second result;
subtracting said third result from said second historical price average.

56. A method according to claim 17 wherein said logic rules for said mountain include the steps of:
determining a high price pattern threshold;
determining a low price pattern threshold;
verifying said first historical price average is less than said low price pattern threshold;
verifying said second historical price average is greater than said high price pattern threshold;
verifying said third historical price average is less than said low price pattern threshold.

57. A method according to claim 56 wherein said high price pattern threshold is determined by the steps of:
determining an absolute value of said first historical price average less said second historical price average;
determining a first result by dividing one by said Price Sector Ratio Coefficient;
determining a second result by multiplying said absolute value by said first result;
adding said second result to said first historical price average.

58. A method according to claim 56 wherein said low price pattern threshold is determined by the steps of:
determining an absolute value of said first historical price average less said second historical price average;
determining a first result by subtracting one from said Price Sector Ratio Coefficient;
determining a second result by dividing one by said first result;
determining a third result by multiplying said absolute value by said second result;
subtracting said third result from said first historical price average.

59. A method according to claim 17 wherein said logic rules for said stumbler include the steps of:
determining a high price pattern threshold;
determining a low price pattern threshold;
verifying said first historical price average is less than said high price pattern threshold;
verifying said first historical price average is greater than said low price pattern threshold;
verifying said second historical price average is greater than said high price pattern threshold;
verifying said third historical price average is less than said low price pattern threshold.

60. A method according to claim 59 wherein said high price pattern threshold is determined by the steps of:
determining an absolute value of said first historical price average less said second historical price average;
determining a first result by subtracting one from said Price Sector Ratio Coefficient;
determining a second result by dividing said Price Sector Ratio Coefficient by said first result;
determining a third result by multiplying said absolute value by said second result;
subtracting said third result from said second historical price average.

61. A method according to claim 59 wherein said low price pattern threshold is determined by the steps of:
determining an absolute value of said first historical price average less said second historical price average;
determining a first result by multiplying said absolute value by said Price Sector Ratio Coefficient;
subtracting said first result from said second historical price average.
